(19) United States
(12) Patent Application Publication
(10) Pub. No.: US 2026/0109286 A1
(43) Pub. Date: Apr. 23, 2026

(54) VEHICLE MOUNTING KIT

(71) Applicant: Luis Hernandez, Artesia, NM (US)

(72) Inventor: Luis Hernandez, Artesia, NM (US)

(21) Appl. No.: 18/923,187

(22) Filed: Oct. 22, 2024

(51) Int. Cl. B60P 3/077

(52) U.S. Cl. CPC B60P 3/077

(57) ABSTRACT

A vehicle mounting kit for mounting a vehicle to a trailer or other support structure includes a front wheel chock and a rear wheel chock. The front wheel chock includes a U-shaped front guardrail which defines a front wheel bay for receiving a front wheel of the vehicle and preventing further forward motion with respect to the front wheel chock. The rear wheel chock defines a bay that allows movement of the vehicle's wheels forward and backward therethrough. The front and rear wheel chocks also include mounting rings for attaching mounting straps that secure the vehicle's wheels to the front and rear wheel chocks.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to vehicle mounting apparatuses and more particularly pertains to a new vehicle mounting apparatus for mounting a vehicle to a trailer or other support structure.

### (2) Description of Related Art Including Information Disclosed Under 37 CFR 1.97 and 1.98.

The prior art discloses vehicle mounting apparatuses which include wheel chocks that extend around a wheel of a vehicle and straps for tethering the vehicle to a trailer or other support structure. The prior art also discloses vehicle mounting apparatuses which include protruding members which wheels of the vehicle are moved over to position the wheels in secured positions and then serve to prevent movement of the wheels once in their secured positions. However, the prior art does not describe a kit comprising a front wheel chock and a rear wheel chock, where the rear wheel chock is open on a front end to allow wheels to travel through a bay defined by the rear wheel chock, and wherein the front wheel chock and the rear wheel chock include mounting structures for securing mounting straps over the wheels of the vehicle.

### (h) BRIEF SUMMARY OF THE INVENTION

An embodiment of the disclosure meets the needs presented above by generally comprising a front wheel chock and a rear wheel chock. The front wheel chock comprises a front chock base plate which has a front end and a rear end and a front guardrail which is coupled to and spaced upwardly from the front chock base plate. The front guardrail has a front section and a pair of lateral sections, wherein the lateral sections are coupled to and extends away from the front section. The front guardrail defines a front wheel bay which is surrounded by the front section and the pair of lateral sections. Each lateral section has a free end opposite the front section. The front wheel chock further comprises a pair of front chock attachment members which are coupled to the front chock base plate. The front chock attachment members are positioned opposite each other across the front guardrail.

The rear wheel chock is positionable remotely from the front wheel chock and comprises a rear chock base plate with a front end and a rear end. The rear wheel chock has a pair of lateral walls which are coupled to the rear chock base plate and extend between the front and rear ends of the rear chock base plate. The rear wheel chock also includes a pair of rear guardrails, each of which is coupled to a top edge of an associated lateral wall of the pair of lateral walls. The rear guardrails define a rear wheel bay therebetween. The rear wheel chock further comprises a pair of rear chock attachment members which are coupled to the rear chock base plate. The rear chock attachment members are positioned opposite each other across the pair of rear guardrails.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective kit view of a vehicle mounting kit according to an embodiment of the disclosure.

FIG. 2 is a top perspective view of a front wheel chock of an embodiment of the disclosure.

FIG. 3 is a top perspective view of a rear wheel chock of an embodiment of the disclosure.

FIG. 4 is a top view of a front wheel chock of an embodiment of the disclosure. FIG. 5 is a cross-section view of a front wheel chock of an embodiment of the disclosure taken from Line 5-5 in FIG. 4.

FIG. 6 is a bottom perspective view of a rear wheel chock of an embodiment of the disclosure.

FIG. 7 is an in-use view of a front wheel chock of an embodiment of the disclosure.

FIG. 8 is an in-use view of an embodiment of the disclosure.

FIG. 9 is a cross-section view of an embodiment of the disclosure taken from Line 9-9 in FIG. 8.

### (J) DETAILED DESCRIPTION OF THE INVENTION

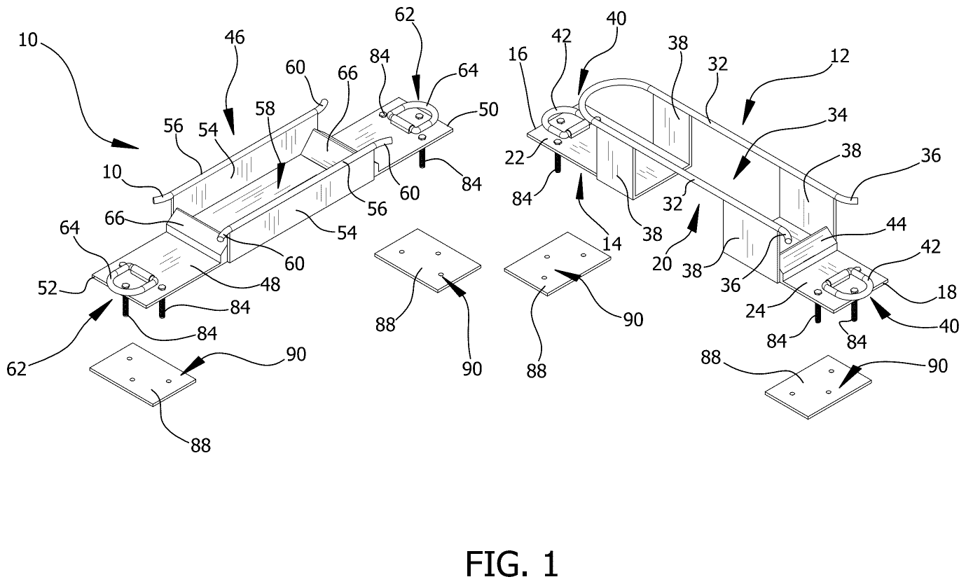

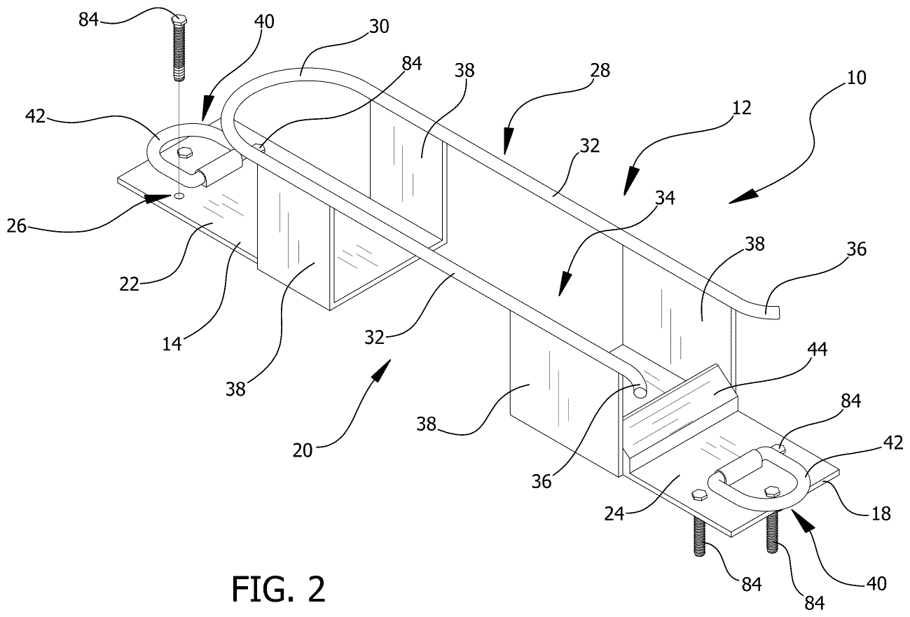

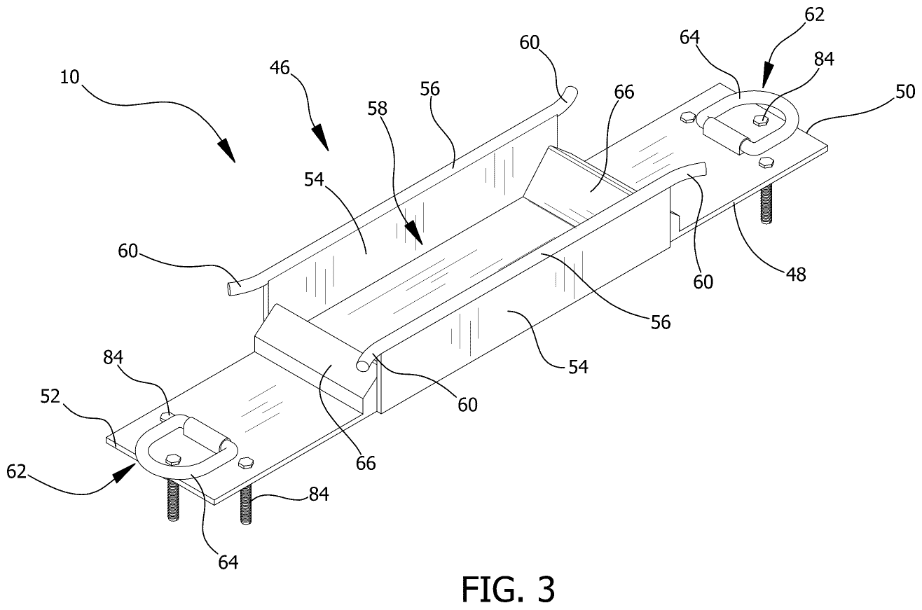

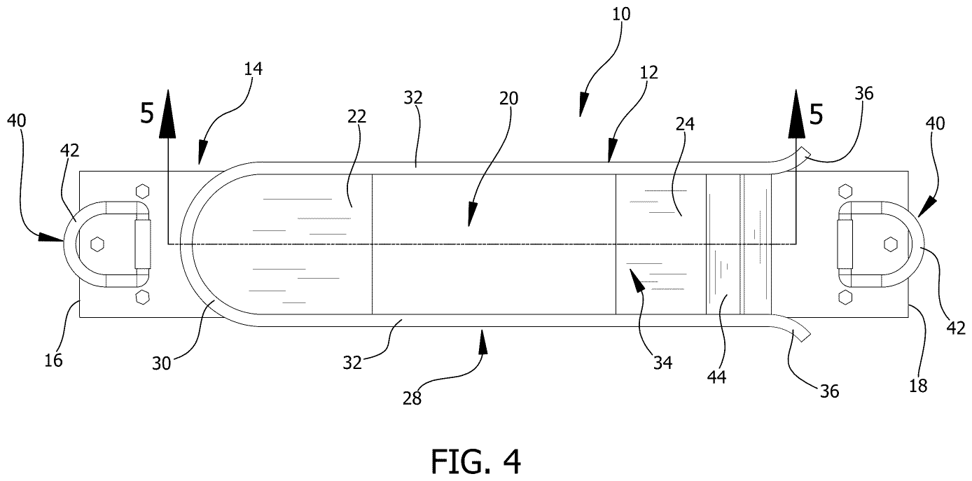

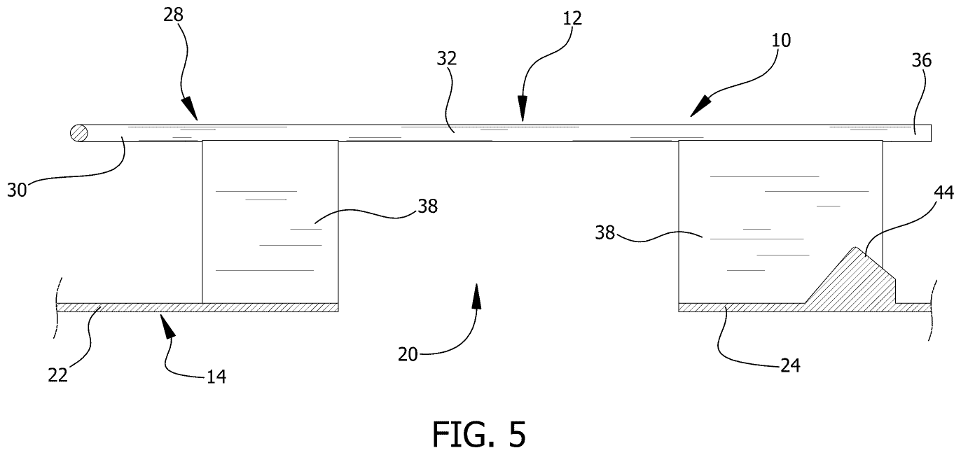

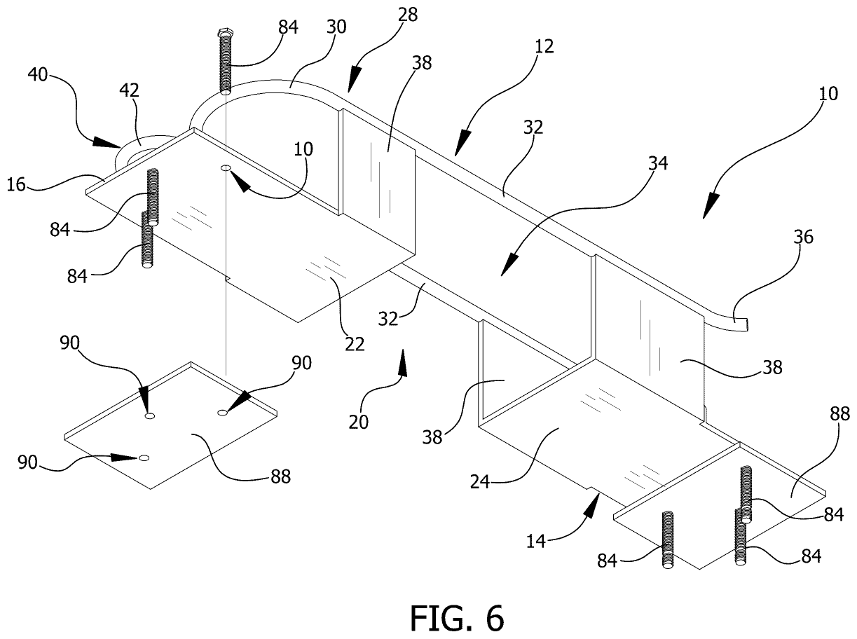

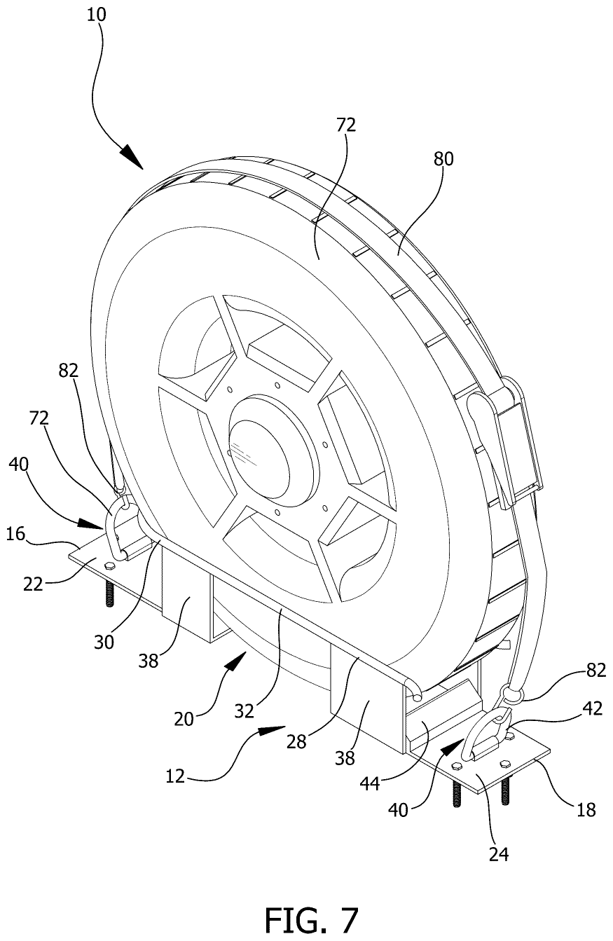

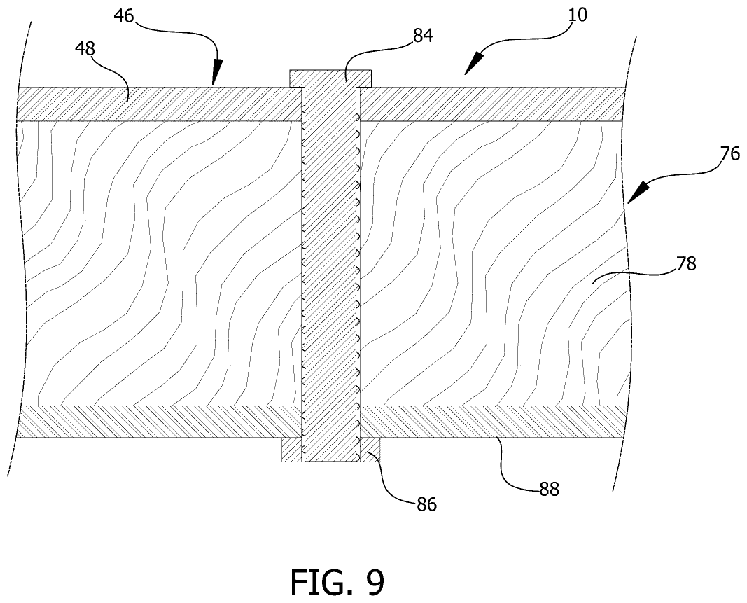

With reference now to the drawings, and in particular to FIGS. 1 through 9 thereof, a new vehicle mounting apparatus embodying the principles and concepts of an embodiment of the disclosure and generally designated by the reference numeral 10 will be described.

As best illustrated in FIGS. 1 through 9, the vehicle mounting kit 10 generally comprises a front wheel chock 12 and a rear wheel chock 46. The front wheel chock 12 comprises a front chock base plate 14 which has a front end 16 and a rear end 18 and has a break 20 which defines a front portion 22 and a rear portion 24 that are spaced from each other. The front chock base plate 14 defines a plurality of front chock mounting holes 26, each of which extends through the front chock base plate 14. Each front chock mounting hole 26 is positioned adjacent to an associated one of the front and rear ends 16, 18 of the front chock base plate 14. The front chock base plate 14 may be mounted to a support structure, such as a trailer, via receiving insertable fasteners, such as threaded fasteners, rivets, or the like, through the plurality of front chock mounting holes 26. In other embodiments, the front chock base plate 14 may be mounted to the support structure via a weldment, clamps, latches, or the like.

The front wheel chock 12 further includes a front guardrail 28 which is coupled to and spaced upwardly from the front chock base plate 14. The front guardrail 28 has a front section 30 and a pair of lateral sections 32, wherein the pair of lateral sections 32 is coupled to and extends away from the front section 30. The front guardrail 28 defines a front wheel bay 34 surrounded by the front section 30 and the pair of lateral sections 32. Each lateral section 32 has a free end 36 opposite the front section 30 which curves laterally outwardly with respect to the front chock base plate 14. The front guardrail 28 has a U-shape wherein the front section 30 is curved and each lateral section 32 of the pair of lateral sections 32 is straight. The U-shape of the front guardrail 28 may be shaped to accommodate and generally conform to a contour of a front wheel of a vehicle. A plurality of spacers 38 is coupled to and extends between the front chock base plate 14 and the front guardrail 28. Each spacer 38 of the plurality of spacers 38 is coupled to an associated one of the front portion 22 and the rear portion 24 of the front chock base plate 14.

The front wheel chock 12 also comprises a pair of front chock attachment members 40 which are coupled to the front chock base plate 14. The front chock attachment members 40 are positioned opposite each other across the front guardrail 28. Each front chock attachment member 40 of the pair of front chock attachment members 40 comprises a front chock ring 42 and is pivotable with respect to the front chock base plate 14. A mounting strap may attach to the front chock attachment members 40 via hooks or the like.

The front wheel chock 12 has a front chock protrusion 44 mounted on and extending upwardly from the front chock base plate 14. The front chock protrusion 44 is positioned between the front chock base plate 14 and the free ends 36 of the pair of lateral sections 32 of the front guardrail 28. The front chock protrusion 44 tapers away from the front chock base plate 14.

The rear wheel chock 46 is positionable remotely from the front wheel chock 12 and securable to the support structure. The rear wheel chock 46 comprises a rear chock base plate 48 which has a front end 50 and a rear end 52. The rear chock base plate 48 defines a plurality of rear chock mounting holes, each of which extends through the rear chock base plate 48. Each rear chock mounting hole is positioned adjacent to an associated one of the front and rear ends 50, 52 of the rear chock base plate 48. The rear chock base plate 48 is configured to mount to the support structure via receiving insertable fasteners, such as threaded fasteners, rivets, or the like, through the plurality of rear chock mounting holes. In other embodiments, the rear chock base plate 48 may be mounted to the support structure via a weldment, clamps, latches, or the like.

The rear wheel chock 46 further includes a pair of lateral walls 54 and a pair of rear guardrails 56. The lateral walls 54 are coupled to the rear chock base plate 48 and extend between the front and rear ends 50, 52 of the rear chock base plate 48. Each rear guardrail 56 is coupled to a top edge of an associated lateral wall 54 of the pair of lateral walls 54. The pair of rear guardrails 56 defines a rear wheel bay 58 therebetween. Each rear guardrail 56 has a pair of end portions 60, each of which curves laterally outwardly with respect to the rear chock base plate 48.

The rear wheel chock 46 also comprises a pair of rear chock attachment members 62 which are coupled to the rear chock base plate 48. The rear chock attachment members 62 are positioned opposite each other across the pair of rear guardrails 56. Each rear chock attachment member 62 of the pair of rear chock attachment members 62 comprises a rear chock ring 64 which is pivotable with respect to the rear chock base plate 48. A mounting strap may attach to the rear chock attachment members 62 via hooks or the like.

The rear wheel chock 46 also includes a pair of rear chock protrusions 66 which are mounted on and extend upwardly from the rear chock base plate 48. The rear chock protrusions 66 are positioned opposite each other across the rear wheel bay 58. Each rear chock protrusion 66 tapers away from the rear chock base plate 48.

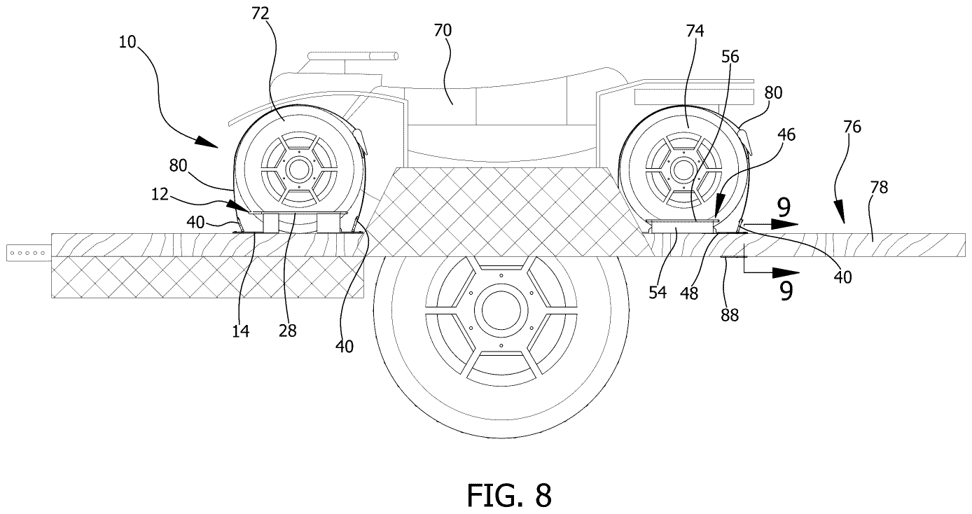

In use, the front wheel chock 12 and the rear wheel chock 46 are mounted to a support structure. FIG. 8 depicts the front wheel chock 12 and the rear wheel chock 46 being mounted on a bed 78 of a trailer 76. Bolts 84 may be inserted through the front chock mounting holes 26 and the rear chock mounting holes, through the bed 78 of the trailer 76, and secured with nuts 86. Fastening plates 88 having through holes 90 which align with the front chock mounting holes 26 and the rear chock mounting holes may also be used on the underside of the bed 78 of the trailer 76 to distribute over an area a clamping force exerted by the nuts 86 and bolts 84 on the bed 78 of the trailer 76.

A vehicle 70 having a front wheel 72 and a rear wheel 74 is driven into a mounting position in which the front wheel 72 is positioned in the front wheel bay 34 of the front wheel chock 12 and the rear wheel 74 is positioned in the rear wheel bay 58 of the rear wheel chock 46. This may be done by moving the vehicle 70 such that the front wheel 72 is moved over the rear chock protrusions 66 through the rear bay and over the front chock protrusion 44 into the front wheel bay 34. The rear wheel 74 follows behind the front wheel 72 until it is positioned in the rear bay of the rear wheel chock 46. While in the front wheel bay 34, the front wheel 72 is surrounded by and may abut the front guardrail 28 and the front chock protrusion 44, each of which acts to retain the front wheel 72 in the front wheel bay 34. While in the rear wheel bay 58, the rear wheel 74 is surrounded by and may abut the pair of rear guardrails 56 and the pair of rear chock protrusions 66, each of which acts to retain the rear wheel 74 in the rear wheel bay 58. The free ends 36 of the lateral sections 32 of the front guardrail 28 and the end sections of the rear guardrails 56 are shaped to guide the front wheel 72 and the rear wheel 74 into the front wheel bay 34 and the rear wheel bay 58.

Mounting straps 80 with hooks 82 at their ends may be used to further secure the front wheel 72 and the rear wheel 74 to the front wheel chock 12 and the rear wheel chock 46 respectively. The hooks 82 of the mounting straps 80 will hook 82 onto respective ones of the front chock rings 42 and the rear chock rings 64 and be tightened to be drawn against the respective one of the front wheel 72 or the rear wheel 74. In other embodiments, the mounting straps 80 may be threaded through the front chock rings 42 and the rear chock rings 64 or otherwise be attached to retain the front wheel 72 in the front wheel bay 34 and the rear wheel 74 in the rear wheel bay 58.

The vehicle 70 shown in FIG. 8 is an all-terrain vehicle, but other vehicles may be used, including motorcycles, mopeds, golf carts, cars, trucks, vans, or the like. For vehicles with four wheels, two front wheel chocks and two rear wheel chocks may be used for the two front wheels and two rear wheels of the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A vehicle mounting kit comprising:
a front wheel chock comprising:
a front chock base plate having a front end and a rear end;
a front guardrail coupled to and spaced upwardly from the front chock base plate, the front guardrail having a front section and a pair of lateral sections, the pair of lateral sections being coupled to and extending away from the front section, the front guardrail defining a front wheel bay surrounded by the front section and the pair of lateral sections, each lateral section of the pair of lateral sections having a free end opposite the front section; and
a pair of front chock attachment members coupled to the front chock base plate, the pair of front chock attachment members being positioned opposite each other across the front guardrail; and
a rear wheel chock, the rear wheel chock being positionable remotely from the front wheel chock, the rear wheel chock comprising:
a rear chock base plate having a front end and a rear end;
a pair of lateral walls coupled to the rear chock base plate, the pair of lateral walls extending between the front and rear ends of the rear chock base plate;
a pair of rear guardrails, each rear guardrail of the pair of rear guardrails being coupled to a top edge of an associated lateral wall of the pair of lateral walls, the pair of rear guardrails defining a rear wheel bay therebetween; and
a pair of rear chock attachment members coupled to the rear chock base plate, the pair of rear chock attachment members being positioned opposite each other across the pair of rear guardrails.

2. The vehicle mounting kit of claim 1, wherein the front chock base plate has a break which defines a front portion and a rear portion which are spaced from each other.

3. The vehicle mounting kit of claim 1, wherein:
the front chock base plate defines a plurality of front chock mounting holes, the plurality of front chock mounting holes extending through the front chock base plate, each front chock mounting hole of the plurality of front chock mounting holes being positioned adjacent to an associated one of the front and rear ends of the front chock base plate, the front chock base plate being configured to mount to a support structure via receiving insertable fasteners through the plurality of front chock mounting holes; and
the rear chock base plate defines a plurality of rear chock mounting holes, the plurality of rear chock mounting holes extending through the rear chock base plate, each rear chock mounting hole of the plurality of rear chock mounting holes being positioned adjacent to an associated one of the front and rear ends of the rear chock base plate, the rear chock base plate being configured to mount to the support structure via receiving insertable fasteners through the plurality of rear chock mounting holes.

4. The vehicle mounting kit of claim 1, wherein the free end of each lateral section curves laterally outwardly with respect to the front chock base plate.

5. The vehicle mounting kit of claim 1, wherein each rear guardrail of the pair of rear guardrails has a pair of end portions, each end portion of each rear guardrail curving laterally outwardly with respect to the rear chock base plate.

6. The vehicle mounting kit of claim 1, wherein the front guardrail has a U-shape wherein the front section is curved and each lateral section of the pair of lateral sections is straight.

7. The vehicle mounting kit of claim 1, wherein the front wheel chock further comprises a plurality of spacers being coupled to and extending between the front chock base plate and the front guardrail.

8. The vehicle mounting kit of claim 1, wherein:
each front chock attachment member of the pair of front chock attachment members comprises a front chock ring; and
each rear chock attachment member of the pair of rear chock attachment members comprises a rear chock ring.

9. The vehicle mounting kit of claim 8, wherein:
each front chock attachment member of the pair of front chock attachment members is pivotable with respect to the front chock base plate; and
each rear chock attachment member of the pair of rear chock attachment members is pivotable with respect to the rear chock base plate.

10. The vehicle mounting kit of claim 1, wherein the first wheel chock further comprises a front chock protrusion mounted on and extending upwardly from the front chock base plate, the front chock protrusion being positioned between the front chock base plate and the free ends of the pair of lateral sections of the front guardrail, the front chock protrusion tapering away from the front chock base plate.

11. The vehicle mounting kit of claim 1, wherein the rear wheel chock further comprises a pair of rear chock protrusions mounted on and extending upwardly from the rear chock base plate, the pair of rear chock protrusions being positioned opposite each other across the rear wheel bay, each rear chock protrusion tapering away from the rear chock base plate.

12. A vehicle mounting kit comprising:
a front wheel chock comprising:
a front chock base plate having a front end and a rear end, the front chock base plate having a break which defines a front portion and a rear portion which are spaced from each other, the front chock base plate defining a plurality of front chock mounting holes, the plurality of front chock mounting holes extending through the front chock base plate, each front chock mounting hole of the plurality of front chock mounting holes being positioned adjacent to an associated one of the front and rear ends of the front chock base plate, the front chock base plate being configured to mount to a support structure via receiving insertable fasteners through the plurality of front chock mounting holes;
a front guardrail coupled to and spaced upwardly from the front chock base plate, the front guardrail having a front section and a pair of lateral sections, the pair of lateral sections being coupled to and extending away from the front section, the front guardrail defining a front wheel bay surrounded by the front section and the pair of lateral sections, each lateral section of the pair of lateral sections having a free end opposite the front section, the free end of each lateral section curving laterally outwardly with respect to the front chock base plate, the front guardrail having a U-shape wherein the front section is curved and each lateral section of the pair of lateral sections is straight;
a plurality of spacers being coupled to and extending between the front chock base plate and the front guardrail, each spacer of the plurality of spacers being coupled to an associated one of the front portion and the rear portion of the front chock base plate;
a pair of front chock attachment members coupled to the front chock base plate, the pair of front chock attachment members being positioned opposite each other across the front guardrail, each front chock attachment member of the pair of front chock attachment members comprising a front chock ring, each front chock attachment member of the pair of front chock attachment members being pivotable with respect to the front chock base plate; and
a front chock protrusion mounted on and extending upwardly from the front chock base plate, the front chock protrusion being positioned between the front chock base plate and the free ends of the pair of lateral sections of the front guardrail, the front chock protrusion tapering away from the front chock base plate; and
a rear wheel chock, the rear wheel chock being positionable remotely from the front wheel chock, the rear wheel chock comprising:
a rear chock base plate having a front end and a rear end, the rear chock base plate defining a plurality of rear chock mounting holes, the plurality of rear chock mounting holes extending through the rear chock base plate, each rear chock mounting hole of the plurality of rear chock mounting holes being positioned adjacent to an associated one of the front and rear ends of the rear chock base plate, the rear chock base plate being configured to mount to the support structure via receiving insertable fasteners through the plurality of rear chock mounting holes;
a pair of lateral walls coupled to the rear chock base plate, the pair of lateral walls extending between the front and rear ends of the rear chock base plate;
a pair of rear guardrails, each rear guardrail of the pair of rear guardrails being coupled to a top edge of an associated lateral wall of the pair of lateral walls, the pair of rear guardrails defining a rear wheel bay therebetween, each rear guardrail of the pair of rear guardrails having a pair of end portions, each end portion of each rear guardrail curving laterally outwardly with respect to the rear chock base plate;
a pair of rear chock attachment members coupled to the rear chock base plate, the pair of rear chock attachment members being positioned opposite each other across the pair of rear guardrails, each rear chock attachment member of the pair of rear chock attachment members comprising a rear chock ring, each rear chock attachment member of the pair of rear chock attachment members being pivotable with respect to the rear chock base plate; and
a pair of rear chock protrusions mounted on and extending upwardly from the rear chock base plate, the pair of rear chock protrusions being positioned opposite each other across the rear wheel bay, each rear chock protrusion tapering away from the rear chock base plate.
